(19) United States
(12) Patent Application Publication
(10) Pub. No.: US 2008/0318453 A1
(43) Pub. Date: Dec. 25, 2008

(54) Compliant pin

(76) Inventor: Philip M. Dancison, Cortland, OH (US)

Correspondence Address: DELPHI TECHNOLOGIES, INC., M/C 480-410-202, PO BOX 5052, TROY, MI, 48007, US

(21) Appl. No.: 11/821,103

(22) Filed: Jun. 20, 2007

(51) Int. Cl. H01R 12/14

(52) U.S. Cl. 439/82; 439/567

(57) ABSTRACT

A pin for insertion into a hole having a diameter and a plating therein is provided. The pin includes a compliant portion including a pair of outwardly biased beam members having an elongate opening therebetween. Each beam has a beam thickness. The beam thickness and the elongate opening are optimized with respect to the diameter such when the pin is inserted into the hole that the compliant portion is limited to a predetermined level of plastic deformation and the compliant portion is limited to a predetermined level of damage imparted upon the hole plating.

### FIELD

The present embodiments relate to an electrical contact, and in particular, to a press fit electrical contact for use with plated through holes.

### BACKGROUND INFORMATION

Press-fit pins are used as solderless permanent connections for electronics that rely on a gas-tight fit between a terminal contact and a plated-through-hole (PTH) of a printed circuit board. Previously, these press-fit portions accomplished a connection using solid non-compliant pins. Such methods were found to be unreliable due to excessive damage to the PTH. Compliant terminal interfaces were developed to provide a spring-like interface, where forces are absorbed by the terminal contact and not the PTH.

Compliant pins typically include a press-fit portion attached to a lead frame for solderless connection to a printed circuit board. The press-fit portion is for pressing electrical contact with the PTH of a printed circuit board. By being plated through, the PTH is lined with copper, plated with nickel, etc., and is connected to surface traces on the printed circuit board to make additional electrical connections. Moreover, a press-fit portion may be a solid design or may include an eye, which allows for compression of the press-fit portion.

Generally, PTH dimensions are governed by International Electrotechnical Commission (IEC) standard number 60352-5 entitled “Solderless connections—Part 5: Press-in connections—General requirements, test methods and practical guidance.” However, IEC 60352-5 only provides a limited number of sizes for the PTH, including for example, diameters of 0.5, 0.55, 0.6, 0.7 0.75, 0.8, 0.85, 0.9, 1.0, 1.45, and 1.6 mm. Moreover, current compliant pins are designed for use only with the limited number of PTH sizes defined in IEC 60352-5.

The embodiments described hereinafter were developed in light of these and other drawbacks associated with press-fitting electrical contacts through plated-through-holes.

### SUMMARY

Disclosed is a pin for insertion into a hole having a diameter and a plating therein. The pin includes a compliant portion including a pair of outwardly biased beam members having an elongate opening therebetween. Each beam has a beam thickness. The beam thickness and the elongate opening are optimized with respect to the diameter such that when the pin is inserted into the hole that the compliant portion is limited to a predetermined level of plastic deformation and the compliant portion is limited to a predetermined level of damage imparted upon the hole plating.

Another embodiment of a compliant pin for insertion into a hole is provided. The hole has a dimension of about one point two millimeters (1.2 mm). The compliant pin includes at least two beams. The beams are defined by an outer curve, an inner curve, and an elongate opening therebetween. The outer curve is defined by a partial radius of about five point four five millimeters (5.45 mm). The inner curve defined by a partial radius of about six point one five millimeters (6.15 mm). The elongate opening has a longitudinal length of three millimeters (3 mm).

In yet another embodiment, a method is disclosed for configuring a pin for insertion into a hole. The method includes selecting a material for the pin, determining a radius for the hole, determining dimensions for the pin, analyzing an interaction of the pin when inserted into the hole, and testing at least one predetermined limit for the interaction.

### BRIEF DESCRIPTION OF THE DRAWINGS

FIG. 1A is a side perspective view of an exemplary compliant pin, according to an embodiment.

FIG. 1B is an end view of the compliant pin of FIG. 1A, according to an embodiment.

FIG. 2A is a side cross-sectional view of an alternative compliant pin when in a relaxed state, according to an embodiment.

FIG. 2B is an end cross-sectional view of the compliant pin of FIG. 2A showing a relaxed state and an inserted state when the compliant pin is fully placed in a plated-through-hole, according to an embodiment.

FIG. 3 is a process for optimizing a compliant pin, according to an embodiment.

### DETAILED DESCRIPTION

A pin is disclosed for insertion into a plated-through-hole (PTH) of a printed circuit board. In one embodiment, the pin is configured as a power pin. However, one of ordinary skill in the art understands that the pin may be configured for any number of purposes, including but not limited to, a signal pin. The pin includes a dual flex-beam design having an eye-of-needle detail that allows the flex-beams to move towards one another when the pin is inserted into the PTH. The PTH has known dimensions, for example, an inner plated diameter of one point two millimeters (1.2 mm).

For each PTH diameter, each pin is designed for use with a particular diameter PTH to optimize certain parameters. For example, the dual flex-beam design (e.g., the compliant portion) includes a pair of outwardly biased beam members that have an elongate opening (or gap) between them. Moreover, each beam has a thickness. Typically, the beam thickness and elongate opening are optimized with respect to the PTH diameter such that when the pin is inserted into the PTH, damage is minimized to the PTH. In addition to minimizing PTH damage, the compliant portion also maximizes contact pressure and pin retention. Such optimization is performed using finite element analysis (FEA) to determine the amount of plastic deformation of the compliant portion and the deformation of the PTH. Additionally, the FEA analysis reveals the contact pressure and pin retention. Thus, the shape and dimensions of the compliant portion may be altered to optimize each parameter of interest.

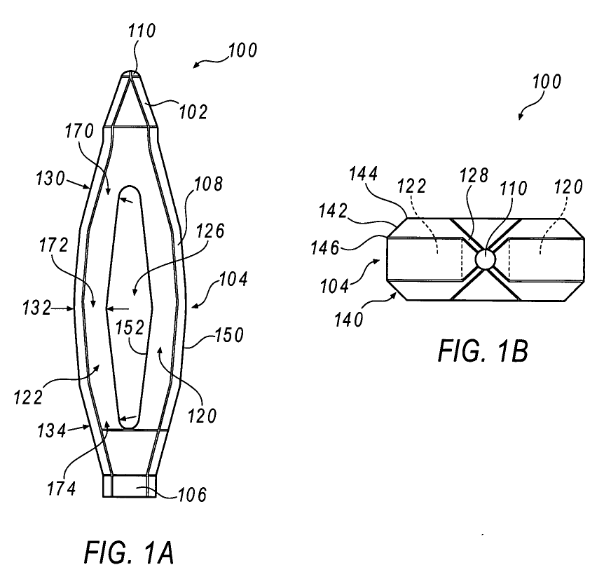

FIG. 1A is a side perspective view of an exemplary compliant pin 100 having a lead-in portion 102, a compliant portion 104, and a lead frame 106. Lead-in portion 102 is configured to be first inserted into the PTH of a printed circuit board. Compliant portion 104 includes a contacting edge 108 configured to interfere with the walls of the PTH and to allow for electrical current flow between compliant portion 104 and the PTH. Lead frame 106 is configured to carry electrical current, for example, to a connector, wire, or circuit board from compliant portion 104.

Lead-in portion 102 includes a tip 110 and generally serves to pilot compliant pin 100 to the PTH. Compliant portion 104 includes a first flex beam 120 and a second flex beam 122 that are separated by an elongate opening 126. First flex beam 120 and second flex beam 122 connect lead-in portion 102 with lead frame 106 and also serve to electrically connect compliant pin 100 with the PTH. Lead frame 106 may comprise a straight box-like portion that extends away from compliant portion 104, but may be configured for any connection to connectors, wires, or other printed circuit boards. Moreover, lead frame 106 may be configured, for example, as a crimp terminal, a female terminal, or to connect to another compliant pin 100.

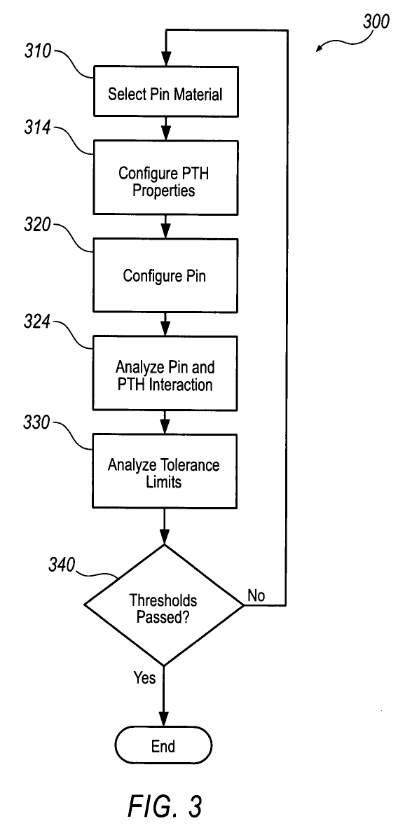

Defining each of beams 120, 122 are an outer curve 150 and an inner curve 152. Outer curve 150 is generally the outer profile of compliant portion 104 and may be a single curve or a piecewise curve, as shown in FIG. 1A, having sections that may be straight or curved. Defining elongate opening 126 is inner curve 152. Inner curve 152 or outer curve 150 may also be shaped to provide thicker or thinner portions of beams 120, 122, depending upon the insertion force, retention force, and acceptable flexing of beams 120, 122 to adjust for the susceptibility of the PTH plating to damage. Thus, the shape or curve of inner curve 152 may be determined by design guidelines depending upon the implementation requirements. As discussed below with respect to FIG. 3, FEA is typically used to determine appropriate forces, deformation, etc. of beams 120, 122 and the PTH.

In the example of FIG. 1A, flex-beam 122 includes three thicknesses defined by outer curve 150 and inner curve 152. A first thickness 130 is near the lead-in portion 102 and is the first part of compliant portion 104 to contact the PTH on both sides of compliant pin 100. A second thickness 132 is near the longitudinal center of compliant portion 104. A third thickness 134 is near the longitudinal end of compliant portion 104 and is what connects flex-beam 120 to lead frame 106. In the example shown, thicknesses 130, 132, 134 are the same and mirrored for flex-beam 122. However, each flex-beam 120, 122 may have different or customized thicknesses 130, 132, 134.

When compliant pin 100 is pressed into a PTH, flex-beams 120, 122 move inwardly due to the pressure applied by the PTH. When flex-beams 120, 122 are forced inwardly, plastic deformation of the material occurs near a first flex point 170. As compliant pin 100 is pressed further inwardly to the PTH, plastic deformation of the material occurs near a second flex point 172 and then near a third flex point 174. Thicknesses 130, 132, 134, the shape, and the material of compliant pin 100 determine the amount of deformation and also the interaction with the plating of the PTH. By adjusting thicknesses 130, 132, 134, a predetermined amount of deformation, or a limited amount of deformation below a threshold, is provided for compliant pin 100 when inserted into a PTH having a known diameter.

FIG. 1B is an end view of compliant pin 100 of FIG. 1A. Lead-in portion 102 includes a lead-in edge 128 that, in the embodiment shown, is a flat facet-like edge. Lead-in edge 128 extends from tip 110 to the beginning of compliant portion 104 (see also FIG. 1A). Compliant portion 104 further includes a flex-beam edge 142 present at each exterior edge of beams 120, 122. As discussed below in detail, flex-beam edge 142 may be optimized for shape to prevent damage to the inner wall of the PTH. In general, beams 120, 122 are configured for shape, thickness, and material, to avoid damaging the inner PTH wall of the PTH (discussed below in detail with respect to FIG. 3).

As shown, flex-beam edge 142 presents a flat surface and further includes a first edge 144 and a second edge 146. When compliant pin 100 is pressed into a PTH, edges 144, 146 will contact the PTH plating to make an electrical contact. Moreover, the mechanical interference will provide the air-tight connection and produce a holding force to maintain compliant pin 100 within the PTH. As shown, edges 144, 146 come to a point. However, other embodiments contemplate a rounded or smooth surface to prevent damage to the PTH plating.

Elongate opening 126 is configured to allow for compression of compliant portion 104. The inward flexing of beams 120, 122 avoids damage to the PTH plating by absorbing the forces present during insertion. When compliant pin 100 is fully inserted in the PTH, beams 120, 122 flex inward but are not in touching contact with one another. In other words, beams 120, 122 are not forced into contact with one another at any point when compliant pin 100 is inserted in the PTH. Moreover, elongate opening 126 begins at the beginning of compliant portion 104 such that during insertion of compliant pin 100 into the PTH, beams 120, 122 always have a space to flex inwardly and avoid damaging the plating of the PTH. In the alternative, any possibly non-compliant portions of compliant pin 100 are designed to be dimensionally less than the PTH inner diameter so that no non-compliant portion is deformed due to contact with the PTH.

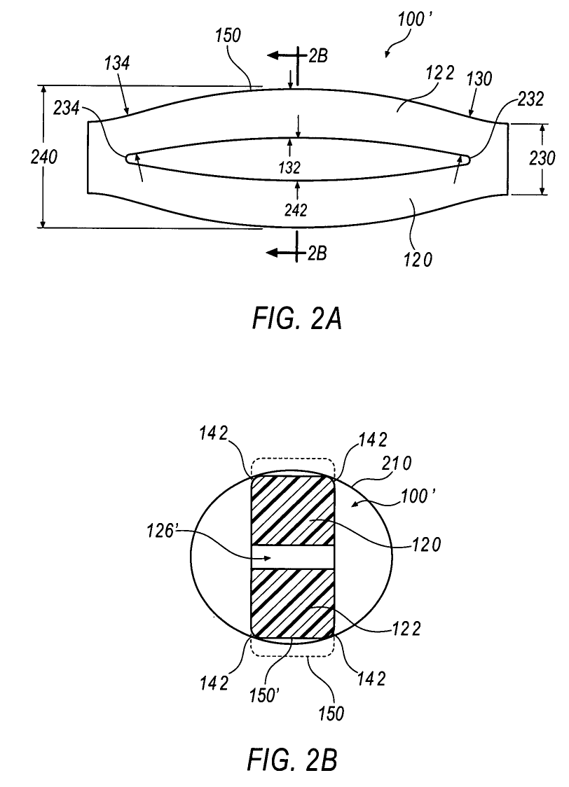

FIG. 2A is a side cross-sectional view of an alternative compliant pin 100′ when in a relaxed state. A relaxed outer dimension D₁ is measured from outer curve 150 of beam 120 to outer curve 150 of beam 122. When compliant pin 100′ is in a relaxed state (e.g., beams 120, 122 are not compressed), relaxed outer dimension D₁ is larger than the diameter of the PTH. In an example where the PTH diameter is one point two millimeters (1.2 mm), outer dimension D₁ is one point four millimeters (1.4 mm). Flex-beam edge 142 may be flat or rounded to avoid damaging the PTH, or more specifically, the plating of the PTH. Because relaxed outer dimension D₁ is larger than the diameter of the PTH, there is necessarily an interference of compliant portion 104 with the PTH when compliant pin 100′ is pressed into the PTH. When elongate opening 126 is in a relaxed state, elongate opening 126 is defined by the space between inner curves 152 of beams 120, 122 that are spaced apart. Of course, when compliant pin 100′ is inserted in a PTH, curve 152 will distort due to the compression of compliant portion 104 and elongate opening 126 reduced in width.

As shown in the example of FIG. 2A, the shape of compliant pin 100′ is less linear than the shape of compliant pin 100 described in FIG. 1A. Outer curve 150 is continuous, e.g. smooth rather than having defined linear sections. Moreover, flex-beam edge 142 is rounded, rather than flat, to reduce damage to PTH plating that may occur during insertion.

FIG. 2B is an end cross-sectional view of compliant pin 100′ of FIG. 2A, showing a relaxed state and an inserted state when the compliant pin is fully placed in a plated-through-hole. The inner plated diameter of a PTH is represented by a PTH aperture 210. PTH aperture 210 is drilled through the circuit board. Typical circuit boards may be made of, for example, FR-4, FR-2, or CEM-1. However, the circuit board may also include any structure or substrate having a hole, wherein the hole includes an inner periphery configured for an electrical connection.

In phantom, a related state for compliant pin 100′ is shown where it is clear that the dimensions of compliant portion 104 (see FIG. 1A) is larger than PTH aperture 210. Thus, when compliant pin 100′ is inserted into the PTH an interference fit occurs. As compliant pin 100′ is inserted, beams 120, 122 are forced towards each other and elongate opening 126′ is made smaller. Moreover, an outer curve 150′ is modified by the bending of beams 120, 122 to fit within PTH aperture 210. The outward pressure exerted by beams 120, 122 maintain compliant pin 100′ within PTH aperture 210. An air-tight electrical contact is made between PTH aperture 210 (or the plating thereof) and compliant pin 100′ at each flex-beam edge 142 (e.g., at the outer corners of each beam 120, 122).

Referring to FIGS. 2A-2B, optimized parameters for compliant pin 100′ are further described. In the example shown, PTH aperture 210 is about one point two millimeters (1.2 mm). A pin width 230 which is about zero point six four millimeters (0.64 mm). Outer curve 150 is defined by a partial radius of about five point four five millimeters (5.45 mm). Inner curve 152 is defined by a partial radius of about six point one five millimeters (6.15 mm). Elongate opening 126 had a longitudinal length of about three millimeters (3 mm). First thickness 130 and third thickness are about zero point three six millimeters (0.36 mm). Second thickness 132 is about zero point four millimeters (0.4 mm). A first end radius 232 and a second end radius 234 are about zero point one five millimeters (0.15 mm). An overall relaxed width 240 of compliant pin 100′ is about one point four millimeters (1.4 mm). A relaxed elongate opening width 242 is about zero point six millimeters (0.6 mm). Flex-beam edge 142 is a chamfer including a radius of about zero point zero eight millimeters (0.08 mm).

FIG. 3 is a process 300 for optimizing a compliant pin (e.g., complaint pins 100, 100′). The process generally tests critical deformation and/or possible damage to compliant pin 100 and the PTH plating when a pin is inserted. The process also optimizes the holding force of the pin when seated in the PTH. The process starts at step 310 where a material is selected for compliant pin 100. In this example, the material selected is a phosphor bronze copper alloy. Such a material is selected for its spring properties and conductivity. The spring properties become important when flex-beams 120, 122 (see FIG. 2A) are compressed to fit in PTH aperture 210 (see FIG. 2B) and flex beams 120, 122 are also required to provide an outward holding force to maintain an air-tight electrical connection with the PTH plating. One example of a phosphor bronze alloy is Copper Development Association alloy number four hundred twenty five (“CDA 425”), which possesses superior current carrying capacity as compared to a phosphor bronze alloy. CDA 425 is typically an “ambronze” that comprises approximately 84% copper, approximately 2% tin, and approximately 14% zinc. Moreover, CDA 425 guarantees automotive high current capacity requirements when used as the base material. However, other materials may also be used, including a phosphor bronze alloy, depending upon the current carrying requirements of compliant pin 100. Where higher currents are required, CDA 425 provides for increased current carrying capability over a phosphor bronze alloy.

Increased current carrying capability is also provided through reduced damage to compliant pin 100 and the PTH plating during insertion and holding. Because lead-in portion 102 is substantially linear, the insertion of compliant pin 100 into PTH aperture 210 does not cause substantial deformation, cutting, or other damage to the PTH plating or compliant pin 100. Thus, the current carrying capability of the PTH plating and flex-beam edge 142 of compliant pin 100 are preserved for high-pressure uninterrupted connection. Thus, a higher current is realized through reduced damage to the PTH plating and to compliant pin 100. Additionally, the substantially linear profile of lead-in portion 102 provides for a reduced insertion force of compliant pin 100. The process continues with step 314.

At step 314, the PTH aperture 210 size and PTH plating material are chosen. Nickel or nickel alloy is a typical plating for through-hole printed circuit boards. However, copper, and silver, and other alloys are also common plating materials. The process continues with step 316.

At step 320, the dimensions for compliant pin 100 are determined. For example, each of beams 120, 122 are defined by an outer curve 150 and an inner curve 152. Moreover, the width of elongate opening 126 is determined, as are thicknesses 130, 132, 134 (see FIG. 1A). The process continues with step 324.

At step 324, FEA is used to determine the effects of pushing compliant pin 100 into PTH aperture 210. That is to say, FEA computationally determines how compliant pin 100 will respond when inserted into the PTH. Moreover, any damage to the plating of the PTH is determined. FEA generally uses computer-aided simulation of physical material properties and real-world reactions to model the pin insertion without the need for empirical experimentation and failure testing. Moreover, FEA provides insight into the magnitude of plastic deformation throughout beams 120, 122 and precisely where the maximum deformation is occurring. Moreover, visualization of the FEA results may be helpful to guide a user to make design changes to achieve their goals. For example, where it is shown that damage is occurring to the PTH plating, a user may reduce thickness 130 and/or 134 so that beams 120, 122 are more readily deformed. However, the user may also balance holding force with the damage to the PTH plating to find an acceptable combination. In this way, the parameters of compliant pin 100 are optimized.

Indeed, the holding force of compliant pin 100 within the PTH may be a limit that must be exceeded, while at the same time certain deformations or damage to compliant pin 100 and/or the PTH must be minimized. Flex-beam edge 142 may also be tested for the effects of different edge profiles, e.g., flat or curved, and the effect of different radiuses on a curved profile.

Essentially, each and every parameter of compliant pin 100 is available to the user for adjustment, including material choice. The user may modify thicknesses, curve profiles, or any other dimension or feature to achieve a desired result. It is also possible to set limits on, for example, plastic deformation of flex points 170, 172, 174 and to have the computer use FEA analysis to iteratively modify design features until the threshold is not exceeded. The process then continues with step 330.

At step 330, the optimized design is tested against standard tolerances for the production of compliant pin 100 and the standard tolerances for the production of the PTH. The process continues with step 340.

At step 340, the finally tested design is compared with the desired criteria for the threshold of deformation of compliant pin 100, the threshold of damage to the plating of the PTH, and the threshold for the holding force of compliant pin 100 within the PTH. Other criteria may also be added, such as costs for materials etc. If each threshold passes, the process ends providing at least one acceptable design. If any of the thresholds fail, the process reverts to step 310 for continued design revision.

The present invention has been particularly shown and described with reference to the foregoing examples, which are merely illustrative of the best modes for carrying out the invention. It should be understood by those skilled in the art that various alternatives to the examples of the invention described herein may be employed in practicing the invention without departing from the spirit and scope of the invention as defined in the following claims. The examples should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

The present embodiments have been particularly shown and described, which are merely illustrative of the best modes. It should be understood by those skilled in the art that various alternatives to the embodiments described herein may be employed in practicing the claims without departing from the spirit and scope as defined in the following claims. It is intended that the following claims define the scope of the invention and that the method and apparatus within the scope of these claims and their equivalents be covered thereby. This description should be understood to include all novel and non-obvious combinations of elements described herein, and claims may be presented in this or a later application to any novel and non-obvious combination of these elements. Moverover, the forgoing embodiments are illustrative, and no single feature or element is essential to all possible combinations that may be claimed in this or a later application.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A pin for insertion into a hole having a diameter and a plating therein, the pin comprising:
a compliant portion comprising a pair of outwardly biased beam members having an elongate opening therebetween and each having a beam thickness;
wherein said beam thickness and said elongate opening are optimized with respect to the diameter of the hole.

2. The pin of claim 1, wherein said compliant portion is limited to a predetermined level of plastic deformation when said pin is inserted into the hole.

3. The pin of claim 1, wherein said compliant portion is limited to a predetermined level of damage imparted upon the hole plating when said pin is inserted into the hole.

4. The pin of claim 1, wherein said beam thickness further comprises a first thickness at a longitudinal midpoint and a second thickness near at least one end.

5. The pin of claim 4, wherein:
the diameter is about one point two millimeters (1.2 mm);
said first thickness is about zero point four millimeters (0.4 mm);
said second thickness is about point three six millimeters (0.36 mm); and
said elongate opening has a width of about zero point six millimeters (0.6 mm).

6. The pin of claim 1, wherein:
the diameter is about one point two millimeters (1.2 mm);
said width beam thickness is about zero point four millimeters (0.4 mm); and
said elongate opening has a width of about zero point six millimeters (0.6 mm).

7. The pin of claim 1, wherein:
the diameter is about one point two millimeters (1.2 mm); and
said width is about zero point four millimeters (0.4 mm).

8. The pin of claim 1, wherein a length of said compliant portion is optimized to reduce engagement force and plastic deformation as the pin is inserted into the hole.

9. The pin of claim 1, wherein said optimization uses finite element analysis (FEA).

10. The pin of claim 1, further comprising:
a lead-in portion connected to said compliant portion, said lead-in portion having a lead-in profile, wherein a width of said lead-in profile continuously narrows from said compliant portion to a tip;
wherein said lead-in profile is different from said beam profile.

11. The pin of claim 1, wherein said beam profile is curved.

12. The pin of claim 1, wherein said pair of outwardly biased beam members further comprise a beam profile.

13. A compliant pin for insertion into a hole having a dimension of about one point two millimeters (1.2 mm), the pin comprising:
at least two beams, said beams defined by an outer curve, an inner curve, and an elongate opening therebetween;
wherein said outer curve defined by a partial radius of about five point four five millimeters (5.45 mm);
wherein said inner curve defined by a partial radius of about six point one five millimeters (6.15 mm); and
wherein said elongate opening has a longitudinal length of three millimeters (3 mm).

14. The pin of claim 13, wherein said at least two beams each include a first thickness near an end of said beam and a second thickness near the middle of said beam;
wherein said first thickness is about zero point three six millimeters (0.36 mm); and
wherein said second thickness is about zero point four millimeters (0.4 mm).

15. The pin of claim 13, wherein said elongate opening includes at least one end defined by a radius of about zero point one five millimeters (0.15 mm).

16. The pin of claim 13, wherein said complaint pin has an overall relaxed width of about one point four millimeters (1.4 mm).

17. The pin of claim 13, wherein said elongate opening comprises a relaxed width of about zero point six millimeters (0.6 mm).

18. A method of configuring a pin for insertion into a hole, the method comprising:
selecting a material for said pin;
determining a radius for said hole;
determining dimensions for said pin;
analyzing an interaction of said pin when inserted into the hole; and
testing at least one predetermined limit for said interaction.

19. The pin of claim 18, wherein analyzing an interaction is performed using finite element analysis (FEA).

20. The pin of claim 18, wherein determining dimensions for said pin further comprises determining dimensions for a compliant pin comprising an eye of the needle feature.

21. The pin of claim 20, wherein determining dimensions for a compliant pin further comprises:
determining a first beam thickness;
determining a second beam thickness;
determining a third beam thickness;
determining an elongate opening length; and
determining an elongate opening width;

22. The pin of claim 18, wherein testing at least one predetermined limit further comprises:
testing a predetermined limit for plastic deformation of a beam of a compliant pin.

23. The pin of claim 18, wherein testing at least one predetermined limit further comprises:
testing damage to a hole plating for said hole when said pin is inserted.
